(19) United States
(12) Patent Application Publication
(10) Pub. No.: US 2021/0077876 A1
(43) Pub. Date: Mar. 18, 2021

(54) TABLE TENNIS RACKET BLADE

(71) Applicant: TAMASU CO., LTD., Tokyo (JP)

(72) Inventor: Mitsuru HAYASE, Saitama (JP)

(21) Appl. No.: 16/629,593

(22) PCT Filed: Mar. 12, 2018
(86) PCT No.: PCT/JP2018/009425

§ 371 Date: Jan. 9, 2020

(30) Foreign Application Priority Data
Aug. 7, 2017 (JP) 2017-152394

(51) Int. Cl. A63B 59/45; B32B 15/04; B32B 25/04; B32B 27/06; B32B 27/18; B32B 7/12

(52) U.S. Cl. CPC A63B 59/45; B32B 15/046; B32B 25/045; A63B 2102/16; B32B 27/18; B32B 7/12; A63B 2209/02; B32B 27/065

(57) ABSTRACT

Provided is a novel technology capable of enhancing repulsion when a blade has a laminate structure including a resin foam and a non-ligneous panel-like member laminated thereon. This table tennis racket blade includes: a resin foam (11); and a non-ligneous panel-like member (15) which is laminarly disposed on the resin foam (11), has bonded thereon a rubber (20) that forms a hitting surface, and has a bending Young's modulus of 12000 MPa or more.

### TECHNICAL FIELD

The present invention relates to a table tennis racket blade.

### BACKGROUND ART

A table tennis racket has a blade (a table tennis racket body), a gripping member fixed to the blade and constituting a handle gripped by a user during use, and a table tennis rubber bonded to the blade to form a ball hitting surface (for example, Patent Literature 1).

The blade has a flat plate shape and is composed of a single plate-shaped article or a laminate with a plurality of plate-shaped articles bonded.

Generally, a table tennis racket blade is composed by mainly using wood as can be seen from the current rules (content of wood: 85% or more), but on the other hand, a blade produced using a non-wood material is also suggested.

In addition, a table tennis racket is required which is lighter as a table tennis racket and gives a faster struck ball, and as one means of providing such a racket, providing a blade having lighter weight and higher repulsion can be contemplated.

Examples of such a non-wood blade include the blade described in Patent Literature 2. In Patent Literature 2, it is proposed that a laminate comprising a core material and an upper plate laminated on the core material is used as a blade and that a plastic and a metal are used for a core material and an upper plate.

### CITATION LIST

### Patent Literature

### Patent Literature 1: JP2010-227371

### Patent Literature 2: JP2000-342733

### SUMMARY OF INVENTION

### Technical Problem

It is an object of the present invention to provide a novel technique capable of enhancing repulsion when a table tennis racket blade is constituted as a laminate including a resin foam and a non-wood plate-shaped article laminated thereon.

### Solution to Problem

In terms of flexibility of product design, it is preferable to be able to improve a table tennis racket blade by various methods, and thus it is desirable to propose a further novel constitution.

The present inventors found that when comparing rubbers, using a heavier rubber results in higher performance of rotating the ball (hereinafter, also referred to as spin performance). On the other hand, in order to be able to easily rotating the ball as well as provide faster speed of the struck ball, it is important to be able to swing a racket completely. Therefore it is desirable that the total weight of the racket does not vary significantly even if the rubber is heavier. Furthermore, repulsion of a table tennis racket is preferably stronger since faster speed of the struck ball can be obtained. Therefore the present inventors attempted to produce a blade having light-weight and stronger repulsion.

The present inventors conceived the idea that a blade is constituted as a laminate including a resin foam and a non-wood plate-shaped article laminated thereon in order to easily adjust the weight of the blade and easily obtain a lighter blade. That constitution is a new constitution of a blade which is not conventionally known.

The present inventors found that repulsion differs depending on the material of the plate-shaped article when the blade is constituted as the above-mentioned laminate. As a result of intensive study, the present inventors have found that when the blade is constituted as a laminate including a resin foam and a non-wood plate-shaped article laminated thereon and satisfying the specified bending Young's modulus, repulsion derived from the blade can be enhanced, and thus completed the present invention.

The subject matters of the present invention are as follows.

[1] A table tennis racket blade comprising a resin foam and a non-wood plate-shaped article which is disposed to be laminated on the resin foam and to which a rubber forming a ball hitting surface is bonded and which has a bending Young's modulus of 12000 MPa or more.

[2] The table tennis racket blade according to [1], wherein the plate-shaped article is a formed article of a fiber-reinforced plastic and/or a metal.

[3] The table tennis racket blade according to [1] or [2], wherein a density of the resin foam is 0.30 g/cm³ or less.

[4] A table tennis racket comprising a table tennis racket blade according to any one of [1] to [3].

### Advantageous Effect of Invention

According to the present invention, it is possible to provide a novel technique capable of enhancing repulsion when a table tennis racket blade is constituted as a laminate including a resin foam and a non-wood plate-shaped article laminated thereon.

### BRIEF DESCRIPTION OF DRAWINGS

FIG. 1 shows a perspective view of the table tennis racket comprising the gripping member of the present embodiment.

FIG. 2 shows a sectional view across the line XX′ in FIG. 1.

FIG. 3 shows a graph showing the relationship between the weight of the rubber and ratio of rotating numbers before and after hitting according to the reference test.

FIG. 4 shows a graph showing the relationship between the material used as a plate-shaped article in Examples and the bending Young's modulus.

FIG. 5 shows a graph showing the relationship between the table tennis racket comprising the blade according to the Examples and ratio of ball speed before and after hitting.

FIG. 6 shows a graph showing the relationship between the table tennis racket comprising the blade according to the Examples and ratio of rotating numbers before and after hitting.

### DESCRIPTION OF EMBODIMENTS

Hereinafter, one embodiment of the present invention will be described in detail.

The present embodiment relates to a table tennis racket blade including a resin foam and a non-wood plate-shaped article (hereinafter also simply referred to as a plate-shaped article) which is disposed to be laminated on the resin foam and to which a rubber forming a ball hitting surface is bonded and which has a bending Young's modulus of 12000 MPa or more.

Hereinafter, as a table tennis racket including the blade according to the present embodiment, a table tennis racket of shakehand type for ball-hitting at both faces (hereinafter, also simply referred to as a table tennis racket) will be described as an illustration. However, the blade of the present invention is not limited to a blade applied to a racket of shakehand type, and may be a blade of pen holder type, for example.

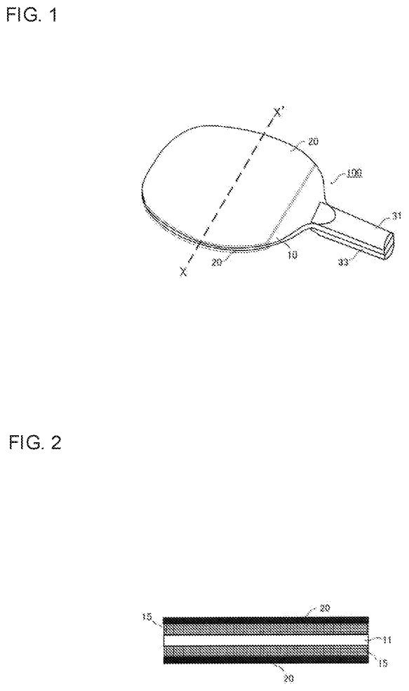

FIG. 1 shows a perspective view of a table tennis racket 100 according to the present embodiment. FIG. 2 shows a sectional view across the line XX′ in FIG. 1.

The table tennis racket 100 of the present embodiment comprises a flat plate-shaped blade (racket body) 10 to both sides of which table tennis rubbers 20 are bonded, and gripping members 31 and 33 fixed to the blade 10 and constituting a handle gripped by a user during use of the racket.

The gripping member is composed of two members, the gripping member 31 disposed on the front side and the gripping member 33 disposed on the back side, which are fixed so as to sandwich the blade 10. The shape and thickness of these gripping members 31 and 33 may also be changed appropriately, and are not particularly limited.

As described above, in the present embodiment, the rubbers 20 are bonded to the surface (front side and back side) of the blade using an adhesive etc. In the present embodiment, the shape and composition etc. of the rubber 20 are not particularly limited, and the rubber selected depending on the preference of a user and the like can be used appropriately.

In the present embodiment, a table tennis racket with a straight type handle is shown as a shakehand type table tennis racket, but it is not limited thereto, and may be a flair type, an anatomic type, a conic type, or the like.

Next, the blade 10 of the present embodiment will be described.

As described above, the blade 10 of the present embodiment is constituted as a laminate having a resin foam 11 and a plate-shaped article 15 which is disposed to be laminated on the resin foam 11 and to which the rubber 20 forming a ball hitting surface is bonded.

The resin foam 11 is a formed article obtained by foaming a resin that may be used for producing foams. In the present embodiment, a resin component is not particularly limited as long as foams may be produced.

Examples of the resin component may include vinyl acetate-based resins such as an ethylene-vinyl acetate copolymer (EVA); vinyl chloride resin (PVC); styrene-based resins such as polystyrene, styrene butadiene resin, acrylonitrile styrene resin (AS resin), and acrylonitrile butadiene styrene resin (ABS resin); olefin-based resins such as low density polyethylene, high density polyethylene, and polypropylene; α-olefin-based resins such as an ethylene-α-olefin copolymer and an ethylene-butene copolymer; ester-based resins such as polyethylene terephthalate and polybutylene terephthalate; amide-based resins such as 6-nylon; vinyl chloride-based resins; acrylic-based resins such as polymethyl methacrylate; poly(meth)acrylimide-based resins such as polymethacrylimide; styrene-based elastomers such as styrene ethylene butylene styrene block copolymers (SEBS); ethylene-vinyl acetate copolymer-based elastomers; olefin-based elastomers; styrene butadiene styrene copolymers (SBS); urethane-based elastomers; ester-based elastomers; fluorine-based elastomers; silicone-based elastomers; polyamide-based elastomers; synthetic rubbers such as butadiene rubber (BR), isoprene rubber (IR), and chloroprene (CR); natural rubbers (NR); copolymer rubbers such as styrene butadiene rubber (SBR), acrylonitrile butadiene rubber (NBR), and butyl rubbers (IIR). The resin foam according to the present embodiment may be constituted, for example, from one or more polymers among them. When the resin foam according to the present embodiment is constituted from two or more polymers, the mixing ratio is not particularly limited, and may be set appropriately by a person skilled in the art.

In addition, the resin foam 11 according to the present embodiment may also contain other components in addition to the resin, and examples of the components may include a blowing agent, a blowing auxiliary, a pigment (a color batch), a cross-linking agent, and an adhesive.

Examples of the blowing agent may include an inorganic blowing agents such as sodium carbonate, sodium hydrogen carbonate, magnesium carbonate, sodium bicarbonate, ammonium carbonate, ammonium bicarbonate, ammonium nitrite, azide compounds, sodium borohydride, and a metal powder; organic blowing agents such as azodicarbonamide (ADCA), azobisformamide, azobisisobutyronitrile, barium azodicarboxylate, N,N′-dinitrosopentamethylenetetramine (DNPT), N,N′-dinitroso-N,N′-dimethylterephthalamide, benzenesulfonyl hydrazide, p-toluenesulfonyl hydrazide, p,p′-oxybisbenzenesulfonyl hydrazide (OBSH), and p-toluenesulfonyl semicarbazide; and physical blowing agents such as hydrocarbons such as pentane, butane, and hexane, halogenated hydrocarbons such as methyl chloride and methylene chloride, gas such as nitrogen and air, and fluorinated hydrocarbons such as trichlorofluoromethane, dichlorodifluoromethane, trichlorotrifluoroethane, chlorodifluoroethane, and hydrofluorocarbon. The blowing agents may be used singly or in combinations of two or more.

Examples of the blowing auxiliary may include urea and a urea derivative; zinc (metal) compounds such as zinc white, zinc stearate, and zinc carbonate; and oxides such as salicylic acid.

In the resin foam according to the present embodiment, the ratio of the components is not particularly limited, and may be set appropriately by a person skilled in the art.

In the present embodiment, the density of the resin foam 11 is preferably 0.30 g/cm³ or less since faster speed of the struck ball can be obtained, and more preferably 0.05 to 0.30 g/cm³. The method of constituting the resin foam 11 so that it has a density of 0.30 g/cm³ or less is not particularly limited, and may be set appropriately by a person skilled in the art.

A commercially available resin foam having a density of 0.30 g/cm³ or less may be subjected to processing of shape and used as the resin foam according to the present embodiment.

In the blade 10 of the present embodiment, the resin foam 11 is disposed in the center of the laminate, and the two non-wood plate-shaped articles 15 are disposed so as to sandwich the resin foam 11. The resin foam 11 and the plate-shaped articles 15 are bonded together using an adhesive, for example. Furthermore, to the surface of each plate-shaped article 15 opposite to the resin foam 11, the rubber 20 is bonded using an adhesive.

The plate-shaped article 15 according to the present embodiment is constituted with a non-wood material having a bending Young's modulus of 12000 MPa or more. In the present specification, “non-wood” means that the material is not the one obtained by processing wood by only a physical treatment.

In the present specification, “bending Young's modulus” is an indicator representing resistance to deformation caused by a force to bend the material, and can be obtained as follows.

The measurement of the bending Young's modulus can be conducted by the method based on “15 Bending test” of JISZ2101. Specifically, the sample size is 50 mm in length and 10 mm in width, the distance between fulcrums is changed to 30 mm and the indentation rate of an attachment is changed to 3 mm/min in a bending tester, and then measurements are conducted. The bending tester may be for example Strograph VE1D manufactured by Toyo Seiki Seisaku-sho, Ltd. The measurement is continued until the indentation of the attachment (recession (deflection of a sample)) reaches 3.0 mm, and the bending Young's modulus is calculated by the following formula according to “15 Bending test” of JISZ2101.

### E=PL³/48IY

E: Bending Young's modulus (MPa)
P: Load applied (N)
Y: Deflection (mm, set at 3.0 mm in this measurement)
L: Distance between fulcrums (mm)
I: Cross-sectional secondary moment (mm⁴)

I=(t³×w)/12

t: Thickness of sample (mm)

w: Width of sample (mm)

The upper limit of the bending Young's modulus is not particularly limited, but may be, for example, 200000 MPa or less in terms of processability of a blade.

The plate-shaped article 15 is not particularly limited as long as it is constituted with a non-wood material, but preferably a formed article constituted with a fiber-reinforced plastic and/or a metal since repulsion can be further enhanced.

In the present specification, a “fiber-reinforced plastic” means a plastic in which fibers are solidified with a resin. Examples of fibers to be used may include carbon fiber, PBO (polyparaphenylene benzobis oxazole) fiber, polyester fiber, aramid fiber, polyarylate fiber, glass fiber, polyethylene fiber, polyamide fiber, and metal fiber. Examples of constitutions of a fiber-reinforced plastic may include a constitution in which fibers aligned in the specified direction are solidified with a resin (UD), a constitution in which a cloth having fibers interweaved therewith is solidified with a resin (cloth), a constitution in which a cloth having two or more fibers interweaved therewith is solidified with a resin (union cloth), a constitution in which one or more short fibers are dispersed in a resin, and a constitution in which fibers are solidified with a resin without being interweaved (unwoven fabric). The types of a resin may be, for example, epoxy resin, urethane resin, melamine resin, melamine urea resin, acrylic resin, phenol resin, unsaturated polyester resin, polyurethane resin, silicone resin, polyimide resin, ABS resin, and polypropylene resin. A plurality of fiber-reinforced plastics may be laminated on the plate-shaped article 15. In that case, as constitutions of fibers, the same constitutions or different constitutions may be used in combination.

Examples of metals may include aluminum, stainless steel, iron, copper, nickel, brass, and titanium.

The method of obtaining the fiber-reinforced plastic having a bending Young's modulus of 12000 MPa or more is not particularly limited and may be a known method. Commercially available products may be used, and, for example, TORAYCA (registered trademark, the same applies hereinafter) from Toray Industries, Inc. and TORAYCA cloth solidified with a resin may be used.

The blade 10 of the present embodiment can be produced by disposing the resin foam 11 between the two plate-shaped articles 15, laminating and fixing them using, for example, an adhesive so as to sandwich the resin foam 11 by the two plate-shaped articles 15.

The respective thicknesses of the resin foam 11 and the plate-shaped article 15 (length in the direction of lamination) are not particularly limited, but may be, for example, 2.0 to 8.0 mm for the resin foam 11, and 2.0 mm or less (preferably 0.05 to 2.0 mm) for the plate-shaped article 15. The thickness of the two plate-shaped article 15 may be the same or different.

In the present embodiment, the weight of the blade 10 is not particularly limited, but the total weight of the blade 10, the gripping members 31 and 33, and an adhesive for fixing them (hereinafter, also referred to as the total weight of the blade and other members) is preferably 100 g or less in terms of weight reduction etc., and in this case, the weight of the blade 10 is preferably 80 g or less in terms of weight reduction etc. More preferably the weight of the blade 10 may be 70 g or less (in that case, preferable total weight of the blade and other members is 90 g or less), even more preferably the weight of the blade 10 may be 60 g or less (in that case, preferable total weight of the blade and other members is 80 g or less). The lower limit of the weight of the blade 10 is also not particularly limited, but may be, for example, 40 g or more (in that case, the total weight of the blade and other members is, for example, 60 g or more) in terms of operability.

As for the weight of the resin foam and each plate-shaped article, for example, the weight of the resin foam is preferably 45 g or less, and the weight of each plate-shaped article is 18 g or less since weight reduction can be achieved compared to the case in which a wood blade is used, more preferably the weight of the resin foam is 2 to 45 g (even more preferably 2 to 30 g, yet even more preferably 5 to 30 g), and the weight of each plate-shaped article 1 to 18 g (even more preferably 1 to 13 g, yet even more preferably 5 to 13 g). The weight of the two plate-shaped articles 15 may be the same or different.

The weight of the table tennis racket 100 (total weight of a blade, gripping members, rubbers, an adhesive, and other members) comprising the blade 10 of the present embodiment is not particularly limited, but is preferably 180 g or less, for example.

In the blade of the present embodiment, the resin foam 11 and the plate-shaped articles 15 are disposed so as to oppose each other and bonded to constitute a laminate, but the form of the blade is not limited thereto, and may be an aspect in which another material is present between the resin foam 11 and the plate-shaped articles 15, as long as the object of the present invention can be achieved.

Thus, according to the present embodiment, when the blade is constituted as a laminated structure including a resin foam and a non-wood plate-shaped article laminated thereon, the bending Young's modulus of the non-wood plate-shaped article is 12000 MPa or more. Therefore, the repulsion of the blade can be enhanced.

As a result, for example, the table tennis racket using a heavier rubber can be constituted without significantly changing the total weight of the table tennis racket. In other words, it is possible to provide a table tennis racket having improved spin performance and performance of the struck ball speed.

### Examples

The present invention will be described more specifically using the following Examples, but the present invention is not limited to the Examples. In the description of the following Examples, a fiber-reinforced plastic is also referred to as a fiber-reinforced material.

### [Reference Test: Rubber Weight and Spin Performance]

A rubber was attached to a stage inclined to have a slope angle of 45 degrees using double-sided tapes.

Then, a table tennis ball (manufacturer: Butterfly, product name: Three-Star ball G40+) was shot at the rubber using a table tennis shooting machine. In that case, the ball speed was set at 7.5 m/s, and the rotating number was set at 61 rps. A moving image of the ball was captured from the moment right before to the moment right after the ball was hit at the rubber (specifically, 10 ms before and after hitting), using a camera (manufacturer: nac Image Technology Inc., product name: MEMRECAM fx K4).

The captured image was analyzed using an analyzing software (manufacturer: nac Image Technology Inc., software: LAA measurement) to calculate the rotating number of the ball right before and right after the ball was hit at the rubber.

Furthermore, the “ratio of rotating numbers before and after hitting” was calculated form the obtained rotating numbers right before and right after hitting.

Three rubbers were tested for each type of rubber. The test result for one rubber is the average value of results of image capturing conducted 5 times.

A rubber had a thickness of 3.88 mm and a size of 8 cm×16 cm (hereinafter, referred to as a test rubber), and rubbers of light type: 27.5 g, medium type: 30 g, and heavy type: 35 g were used.

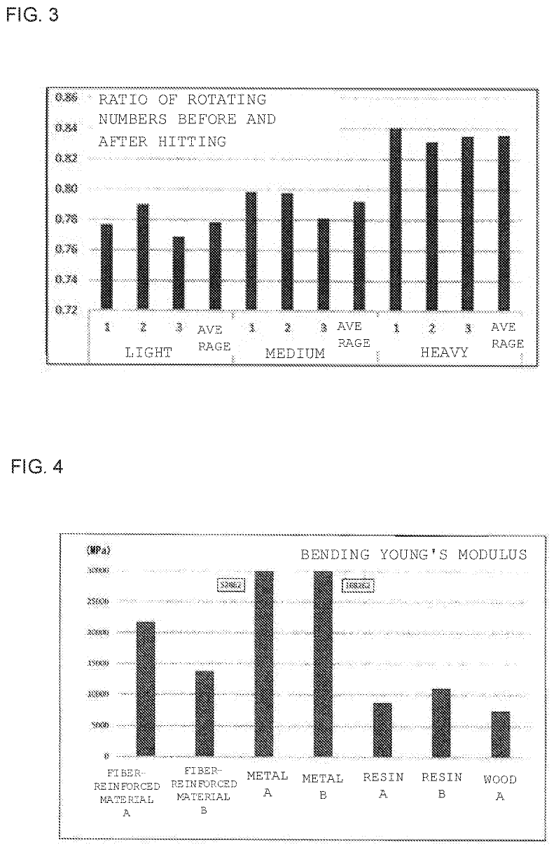

The results are shown in FIG. 3.

As shown in FIG. 3, it can be understood that increasing of the rubber weight provides increasing of the ratio of rotating numbers before and after hitting, resulting in enhancement of spin performance.

### [Bending Young's Modulus]

Measurements of the bending Young's modulus of plate-shaped articles were conducted according to the method based on “15 Bending test” of JISZ2101.

The sample size was 50 mm in length and 10 mm in width, the distance between fulcrums was set to 30 mm and the indentation rate of an attachment was set at 3 mm/min, and then measurements were conducted using Strograph VE1D manufactured by Toyo Seiki Seisaku-sho, Ltd.

The measurement was continued until the indentation of the attachment reached 3.0 mm, and the bending Young's modulus was calculated from the relationship between the recession (deflection of a sample) and stress using the formula according to “15 Bending test” of JISZ2101.

The results are shown in FIG. 4. As shown in FIG. 4, any of a fiber-reinforced material A, a fiber-reinforced material B, a metal A, and a metal B had a bending Young's modulus of 12000 MPa or more. The bending Young's modulus of the fiber-reinforced material A was 21650 MPa, the bending Young's modulus of the fiber-reinforced material B was 13830 MPa, the bending Young's modulus of the metal A was 52862 MPa, and the bending Young's modulus of the metal B was 168262 MPa.

The materials used for measurement of the bending Young's modulus are as follows.

Fiber-reinforced material A: Carbon fibers (TORAYCA from Toray Industries, Inc.) were aligned in the specified direction and formed into a plate-shape with an epoxy resin. Two of the resulting formed products were bonded together so that one of the formed products had fibers aligned in the same direction as the longitudinal direction of the blade 10 (0-degree formed article) and the other formed product had fibers aligned in the direction of the short-length direction (90-degree formed article) and so that the 0-degree formed article was disposed as a surface material of the blade 10. After that, the resulting laminate was cut into the specified size (50 mm×10 mm) and used (thickness of 0.36 mm, density of 1.6 g/cm³, weight of 0.30 g).

Fiber-reinforced material B: Carbon fibers (TORAYCA from Toray Industries, Inc.) were aligned in the specified direction and formed into a plate-shape with an epoxy resin. Two of the resulting formed products were bonded together so that one of the formed products had fibers aligned in the direction rotated counterclockwise by 45 degrees from the longitudinal direction of the blade 10 (45-degree formed article) and the other formed product had fibers aligned in the direction rotated clockwise by 45 degrees (−45-degree formed article) and so that the 45-degree formed article was disposed as a surface material of the blade 10. The resulting laminate was cut into the specified size (50 mm×10 mm) and used (thickness of 0.36 mm, density of 1.6 g/cm³, weight of 0.3 g).

For metals, resins, and wood, commercially available metal plates and resin plates were purchased, cut into the specified size (50 mm×10 mm) and used.

Metal A: Aluminum plate having a density of 2.7 g/cm³, a weight of 1.3 g, and a thickness of 1.0 mm

Metal B: Stainless steel plate having a density of 7.7 g/cm³, a weight of 1.2 g, and a thickness of 0.3 mm

Resin A: Bakelite plate having a density of 1.3 g/cm³, a weight of 0.65 g, and a thickness of 1.0 mm

Resin B: Melamine plate having a density of 1.5 g/cm³, a weight of 0.67 g, and a thickness of 0.9 mm

Wood A: African wood having a density of 0.8 g/cm³, a weight of 0.25 g, and a thickness of 0.62 mm

### Production of the Blade of Examples

The fiber-reinforced material A, the fiber-reinforced material B, the metal A, or the metal B was bonded to the front side and back side of a resin foam A or a resin foam B using an epoxy resin to produce a blade of shakehand type (blade of Examples).

As Comparative Examples, the resin A, the resin B, or the wood A was bonded to the front side and back side of the resin foam A or the resin foam B using an epoxy resin to produce a blade of shakehand type.

The weight of each part of the blade and the total weight for each Example and Comparative Example are shown in Table 1.

The resin foam A and the resin foam B were produced as follows.

Resin foam A: A foam having a density of 0.2 g/cm³ and a thickness of 4.0 mm or 5.0 mm (vinyl chloride-based resin foam) was purchased, cut into the specified size and used.

Resin foam B: A foam having a density of 0.1 g/cm³ and a thickness of 5.0 mm (acrylic resin foam) was purchased, cut into the specified size and used.

TABLE 1

| | | | | Total |
|---|---|---|---|---|
| | | Weight (g) | Weight (g) | weight (g) |
| | | of blade | of rubber | of racket |
| Example 1 | Fiber-reinforced | 47 | 107 | 179 |
| | material B × Foam A | | | |
| Comparative | Wood A × Foam A | 48 | 106 | 180 |
| example 1 | | | | |
| Example 2 | Fiber-reinforced | 49 | 104 | 177 |
| | material A × Foam A | | | |
| Example 3 | Metal A × Foam B | 55 | 103 | 184 |
| Example 4 | Metal B × Foam B | 56 | 103 | 186 |
| Comparative | Resin B × Foam B | 63 | 91 | 178 |
| example 2 | | | | |
| Comparative | Conventional wood | 65 | 90 | 181 |
| example 3 | racket A | | | |
| Comparative | Conventional wood | 68 | 87 | 184 |
| example 4 | racket B | | | |
| Comparative | Resin A × Foam A | 68 | 86 | 179 |
| example 5 | | | | |

*The weight of a rubber is total weight of two rubbers.

[Measurement of Ratio of Ball Speed Before and after Hitting and Ratio of Rotating Numbers Before and after Hitting]

The test rubbers were bonded to both sides of blades of the Examples and the Comparative Examples using an adhesive (manufacturer: Butterfly, product name: Free Chack II) to form a table tennis racket. The racket was inclined so that the ball hitting surface had a slope angle of 45 degrees, and the handle part of the racket was fixed using a fixing tool.

Then, a table tennis ball (manufacturer: Butterfly, product name: Three-Star ball G40+) was shot at the rubber using a table tennis shooting machine. In that case, the ball speed was set at 7.5 m/s, and the rotating number was set at 61 rps. A moving image of the ball was captured from the moment right before to the moment right after the ball was hit at the rubber (specifically, 10 ms before and after hitting), using a camera (manufacturer: nac Image Technology Inc., product name: MEMRECAM fx K4).

The captured image was analyzed using an analyzing software (manufacturer: nac Image Technology Inc., software: LAA measurement) to calculate the rotating number and speed of the ball right before and right after the ball was hit at the rubber.

Furthermore, the “ratio of rotating numbers before and after hitting” and the “ratio of ball speed before and after hitting” were calculated form the obtained rotating numbers and speed of the ball right before and right after hitting. The result for each racket is the average value of results of image capturing conducted 5 times.

A five-ply wood racket (blade having a density of 0.46 g/cm³ and a thickness of 5.9 mm) and a five-ply wood racket (blade having a density of 0.48 g/cm³ and a thickness of 5.9 mm) which were conventional table tennis rackets constituted by bonding the same test rubbers as the Examples were used as Comparative Examples 3 and 4, respectively.

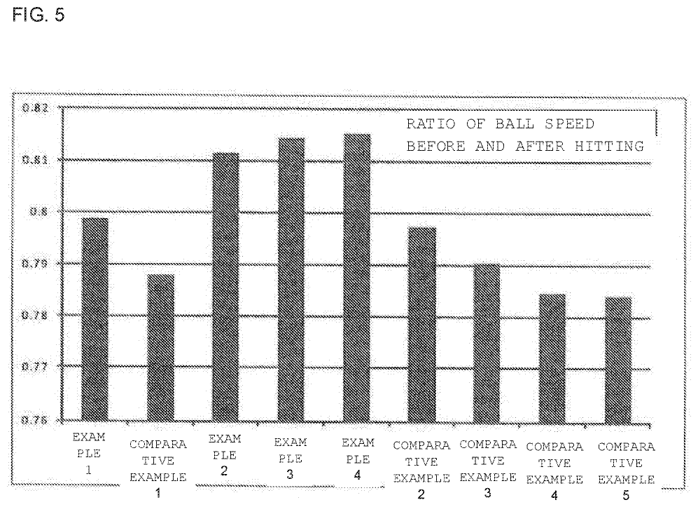

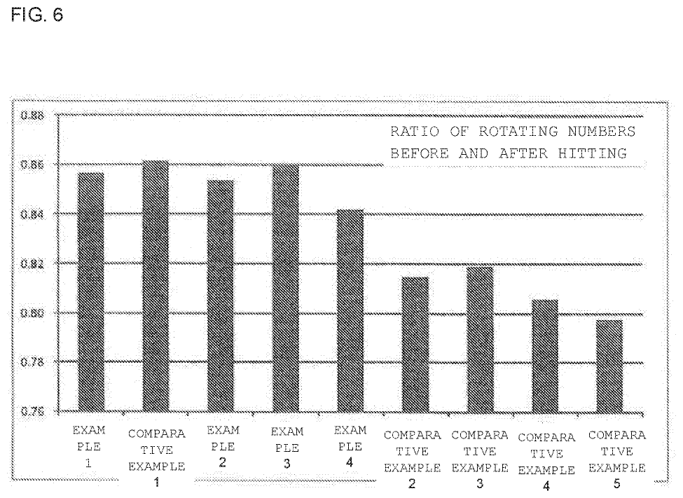

The results are shown in FIGS. 5 and 6.

As shown in FIG. 5, it can be understood that for the racket of the Examples in which the plate-shaped article having a bending Young's modulus of 12000 MPa or more was used, the ratio of ball speed before and after hitting was higher, and thus the repulsion of the blade of the Examples was higher. In addition, as shown in FIG. 6, it can be understood that for the racket of the Examples in which the plate-shaped article having a bending Young's modulus of 12000 MPa or more was used, the ratio of rotating numbers before and after hitting was higher, and thus the spin performance was enhanced.

### REFERENCE SIGNS LIST

10 Blade
11 Resin foam
15 Plate-shaped article
20 Rubber
31 and 33 Gripping member
100 Table tennis racket

1. A table tennis racket blade comprising
a resin foam and
a non-wood plate-shaped article which is disposed to be laminated on the resin foam and to which a rubber forming a ball hitting surface is bonded and which has a bending Young's modulus of 12000 MPa or more.

2. The table tennis racket blade according to claim 1, wherein the plate-shaped article is a formed article of a fiber-reinforced plastic and/or a metal.

3. The table tennis racket blade according to claim 1, wherein a density of the resin foam is 0.30 g/cm³ or less.

4. A table tennis racket comprising a table tennis racket blade according to claim 1.

5. The table tennis racket blade according to claim 2, wherein a density of the resin foam is 0.30 g/cm³ or less.

6. A table tennis racket comprising the table tennis racket blade according to claim 2.

7. A table tennis racket comprising the table tennis racket blade according to claim 3.

8. A table tennis racket comprising the table tennis racket blade according to claim 5.
